(19) United States
(12) Patent Application Publication
(10) Pub. No.: US 2003/0121998 A1
(43) Pub. Date: Jul. 3, 2003

(54) Fuel injection valve

(76) Inventors: Martin Maier, Moeglingen (DE); Joerg Heyse, Besigheim (DE)

Correspondence Address: KENYON & KENYON, ONE BROADWAY, NEW YORK, NY, 10004, US

(21) Appl. No.: 10/181,072

(22) PCT Filed: Nov. 12, 2001
(86) PCT No.: PCT/DE01/04209

(30) Foreign Application Priority Data
Nov. 11, 2000 (DE) 10056006.7

(51) Int. Cl. B05B 1/30

(52) U.S. Cl. 239/585.1

(57) ABSTRACT

A fuel injector has a movable valve part (20), which for opening and closing of the valve cooperates with a stationary valve seat (27) which is formed on a valve seat element (26). A swirl disk (30) is situated downstream from the valve seat (27) and has a multilayer design. The fuel flowing through is imparted to a swirl component between at least one inlet area (65) and at least one outlet area (79). In a first swirl-generating plane (59) a swirl component is imparted to a first portion of the flow, while a second portion of the flow without swirl and independent of the first swirling portion of the flow is routed inside the swirl disk (30), and in a second swirl-generating plane (61) a swirl component is imparted only to the second portion of the flow.

The fuel injector is particularly suitable for direct injection of fuel into a combustion chamber of an internal combustion engine having compression of a fuel/air mixture with spark ignition.

### BACKGROUND INFORMATION

The present invention relates to a fuel injector according to the preamble of claim 1.

A fuel injector which can be electromagnetically actuated is already known from German Unexamined Patent Application 196 37 103, in which swirl-generating means are provided downstream from a valve seat. The swirl-generating means are shaped in such a way that at least two streams can be created from the fuel which run radially offset with respect to one another while mutually enveloping or enclosing one another and which have different directional orientations. The arrangement for creating the injection jet composed of an inner and an outer stream having different directional orientations is quite complicated and relatively expensive to manufacture on account of the flow blades which serve as guide elements and the multilayer swirl mountings on a perforated disk. The swirl-generating means are designed in such a way that either a swirling solid conical jet or a swirling hollow conical jet exits from the fuel injector.

The technique known as multilayer metal plating for the manufacture of perforated disks which are particularly suited for use in fuel injectors has already been described in detail in German Unexamined Patent Application 196 07 288. This principle for manufacturing disks by multiple metal electrodeposition of various structures one on top of the other to produce a one-piece disk is expressly included in the disclosure content of the present invention. Microelectrodeposition in multiple planes or layers can also be used to manufacture the swirl disks according to the present invention.

### ADVANTAGES OF THE INVENTION

The fuel injector according to the present invention having the characterizing features of claim 1 has the advantage that the fuel injector achieves a very high-quality atomization of a fuel to be injected. Using the fuel injector according to the present invention, it is possible to generate a double swirl in a swirl disk which is integrated into the fuel injector, the double swirl generation taking place in the same direction in the fluid so that a finely atomized, hollow conical spray jet composed of two hollow conical lamellae concentrically arranged one inside the other is injected. As a result, among other things, the exhaust emissions from the internal combustion engine may be reduced and likewise the fuel consumption may be decreased in a fuel injector of an internal combustion engine.

Advantageous refinements and improvements of the fuel injector characterized in claim 1 are possible through the measures characterized in the subclaims.

The swirl-generating element is advantageously designed in the shape of a multilayer swirl disk so that it is possible to create a double swirl. It is particularly advantageous to manufacture the swirl disk using the technique known as multilayer metal plating. On account of their metallic construction, such swirl disks are very break-resistant and easy to install. Use of multilayer metal plating allows extremely high freedom in the design, since the contours of the opening areas (inlet area, swirl channels, swirl chambers, outlet openings) in the swirl disk may be freely selected. Compared to silicon discs in particular, whose crystal axes strictly dictate the contours which may be achieved (truncated pyramids), this flexible shaping is very advantageous.

In comparison to the manufacture of silicon disks in particular, metal deposition has the advantage of a very large variety of usable materials. Many varied types of metals having different magnetic properties and hardnesses may be used in microelectrodeposition for the manufacturing of swirl disks.

It is particularly advantageous to construct the swirl disks using five layers by carrying out four or five, for example, electrodeposition steps for multilayer metal plating. The upstream layer represents a top layer which completely covers the swirl chamber of a first middle swirl-generating layer. The swirl-generating layer is formed from a plurality of material areas which on account of their contouring and geometric position with respect to one another determine the contours of the swirl chambers and swirl channels. This also applies to a second middle swirl-generating layer which is separated from the first swirl-generating layer by a middle forwarding layer, but which is in hydraulic connection with the first swirl-generating layer via flow openings in the forwarding layer. A swirling portion of the flow as well as a portion of the flow without swirl and independent of the swirling portion of the flow enter the forwarding layer, the portion of the flow without swirl being transmitted into the second swirl-generating layer for imparting swirl. The individual layers are successively applied to one another by electrodeposition, without separation areas or joint areas, in such a way that they represent a material which is homogeneous throughout. In this regard, the term “layers” is intended as a conceptual aid.

The swirl disc is advantageously provided with at least two, or alternatively four, swirl channels for each swirl-generating layer for imparting a swirl component to the fuel. The material areas may have very different shapes, corresponding to the desired contouring.

### DRAWING

An exemplary embodiment of the present invention is illustrated in simplified form in the drawing and explained in greater detail in the following description.

FIG. 1 shows a partial section of a fuel injector,

FIG. 2 shows a partial section through a swirl disk which may be integrated into the fuel injector, and

FIGS. 3 through 7 show conceptual top views of the individual plies or layers of the swirl disk according to FIG. 2.

### DESCRIPTION OF THE EXEMPLARY EMBODIMENTS

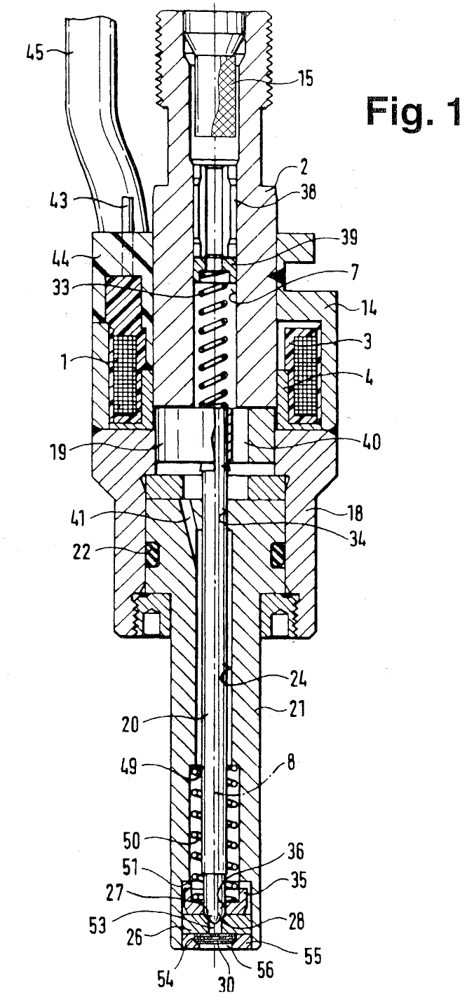

The valve, which as an example is illustrated in FIG. 1 as electromagnetically activatable, and in the form of an injector for fuel injection systems in internal combustion engines having compression of a fuel/air mixture with spark ignition, has a tubular, substantially hollow cylindrical core 2 which is at least partially enclosed by a solenoid 1 and which acts as an internal pole of a magnetic circuit. The fuel injector is particularly suitable as a high-pressure injector for direct injection of fuel into a combustion chamber of an internal combustion engine.

A bobbin 3 made of plastic, which has a stepped design, for example, accommodates a winding of solenoid 1 and, in conjunction with core 2 and an annular, nonmagnetic intermediate part 4 which is partially enclosed by solenoid 1, allows a particularly compact and short design of the injector in the region of solenoid 1.

A continuous longitudinal opening 7 is provided in core 2 which extends along a longitudinal valve axis 8. Core 2 of the magnetic circuit also serves as a fuel inlet connector, longitudinal opening 7 representing a fuel supply duct. Above solenoid 1, core 2 is firmly attached to outer metallic (ferritic, for example) housing part 14, which as a stationary pole or external guide element closes the magnetic circuit and completely encloses solenoid 1, at least in the circumferential direction. A fuel filter 15 is provided on the inflow side in longitudinal opening 7 of core 2 for filtering out fuel components which because of their size could cause blockage or damage in the injector.

A lower tubular housing part 18 is tightly and permanently joined to upper housing part 14 and encloses or accommodates an axially movable valve part having an armature 19, a rod-shaped valve needle 20, and an elongated valve seat support 21. Both housing parts 14 and 18 are permanently joined together by a circumferential weld, for example. The seal between housing part 18 and valve seat support 21 is created by a sealing ring 22, for example.

With its lower end 25, which at the same time represents the downstream end of the entire fuel injector, valve seat support 21 encloses a disk-shaped valve seat element 26 which is fitted into a through opening 24 and which has valve seat face 27 tapering in the downstream direction in the shape of a frustum, for example. Valve needle 20 is situated in through opening 24 and has a valve closing section 28 on its downstream end. This valve closing section 28, which tapers in a conical shape, for example, cooperates in a known manner with valve seat face 27. Downstream from valve seat face 27, following valve seat element 26, there is a swirl-generating element in the form of a swirl disk 30 which is manufactured by multilayer metal plating, for example, and which has five metallic layers successively deposited on one another.

The injector is actuated in a known manner, for example by electromagnetic means. The electromagnetic circuit, which has solenoid 1, core 2, housing parts 14, and 18, and armature 19, is used to axially move valve needle 20 and thus to open the injector against the elastic force of a restoring spring 33 situated in longitudinal opening 7 of core 2, and to close the injector. In order to guide valve needle 20 during its axial movement together with armature 19 along longitudinal valve axis 8, a guide opening 34 provided in valve seat support 21 on the end facing toward armature 19, and a disk-shaped guide element 35, having a dimensionally accurate guide opening 36 is provided upstream from valve seat element 26.

Instead of the electromagnetic circuit, another energizable actuator such as a piezoelectric stack may be used in a comparable fuel injector, or the axially movable valve part may be actuated by hydraulic pressure or servopressure.

An adjusting sleeve 38 which is inserted, pressed, or screwed into longitudinal opening 7 of core 2 is used for adjusting the spring pre-tension of restoring spring 33, which on its upstream side rests on adjusting sleeve 38 via a centering element 39, and which on its other side is supported by armature 19. One or multiple borehole-like flow channels 40 are provided in armature 19 through which the fuel is able to travel from longitudinal opening 7 in core 2, via connecting channels 41 situated downstream from flow channels 40 near guide opening 34 in valve seat support 21, to through opening 24.

The lift of valve needle 20 is predetermined by the installation position of valve seat element 26. When solenoid 1 is not energized, one end position of valve needle 20 is determined by the contact of valve closing section 28 with valve seat face 27, and when solenoid 1 is energized, the other end position of valve needle 20 is determined by the contact of armature 19 with the downstream end face of core 2.

Solenoid 1 is electrically contacted and thus energized via contact elements 43 which are provided with a plastic extrusion coating 44 on the outside of bobbin 3 and which in their continuation run as a connecting cable 45. Plastic extrusion coating 44 may also extend over additional components (housing parts 14 and 18, for example) of the fuel injector.

A first shoulder 49 in through opening 24 acts as a contact surface for a pressure spring 50 having a helical shape, for example. A second level 51 creates an enlarged space for the installation of three disk-shaped elements 35, 26, and 30. Pressure spring 50, which envelops valve needle 20, pretensions guide element 35 in valve seat support 21 by pressing against guide element 35 with its side which is situated opposite shoulder 49. An outlet opening 53 is introduced in valve seat element 26, downstream from valve seat face 27, through which the fuel flowing along valve seat face 27 flows when the valve is open in order to subsequently enter swirl disk 30. Swirl disk 30 is situated, for example, in a recess 54 in a disk-shaped retaining element 55 which is firmly attached to valve seat support 21 by welding, gluing, or clamping, for example. A central outlet opening 56 is formed in retaining element 55 through which the swirling fuel leaves the fuel injector.

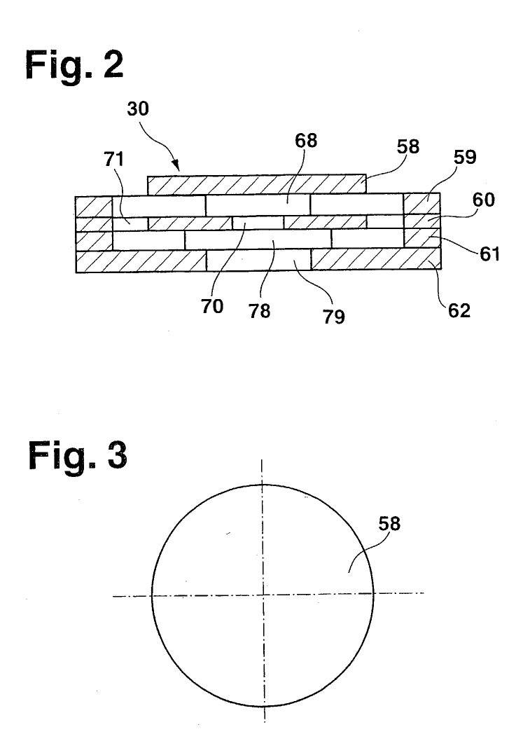

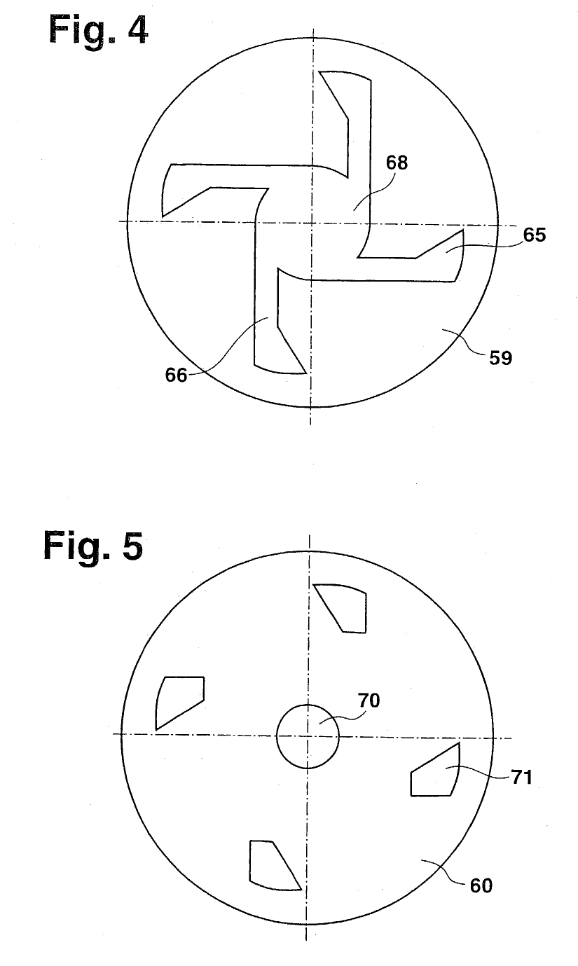

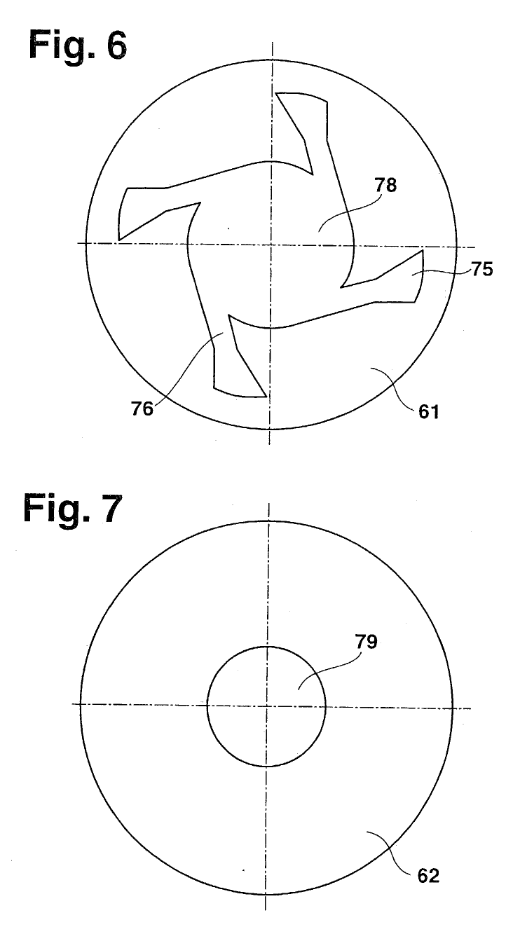

FIG. 2 shows a partial section through swirl disk 30, while FIGS. 3 through 7 show conceptual top views of the individual layers of the swirl disk according to FIG. 2.

Swirl disk 30 is formed from five flat planes or layers, joined together by electrodeposition, which in the installed state are arranged successively in the axial direction. In the following description, the five layers of swirl disk 30 are designated, according to their function, as top layer 58, first swirl-generating layer 59, forwarding layer 60, second swirl-generating layer 61, and base layer 62. For better fuel flow into swirl disk 30, for example, upper top layer 58 has a smaller outer diameter than all the other layers 59, 60, 61, 62.

In this manner it is ensured that the fuel is able to flow from the outside, past top layer 58 and, thus unhindered, to enter outer inlet areas 65 of four, for example, swirl channels 66 in first swirl-generating layer 59. Upper top layer 58 represents a closed metallic layer which has no opening areas permitting flow-through. First swirl-generating layer 59 is provided with a complex opening contour which runs over the entire axial depth of this layer 59. The opening contour of layer 59 is formed from an internal swirl chamber 68 and a plurality (two, four, six, or eight, for example) of swirl channels 66 opening into swirl chamber 68. In the illustrated embodiment, swirl disk 30 has four swirl channels which open tangentially into swirl chamber 68.

Whereas swirl chamber 68 is completely covered by top layer 58, swirl channels 66 are only partially covered, since the outer ends facing away from swirl chamber 68 form inlet areas 65 which are open on top. In the region of a middle forwarding layer 60 situated immediately downstream, the flow is divided into two parts, a first and a second portion of the flow, since in addition to a central through opening 70 there are additional outer through openings 71 provided in forwarding layer 60 which extend in the same number of swirl channels 66, downstream from and directly below inlet area 65. The second portion of the flow enters through these through openings 71 and does not take the path through swirl channels 66 in swirl-generating layer 59 situated above. The first portion of the flow flows through swirl channels 66 into swirl chamber 68, and from there into flow opening 70, which has a rather small diameter, the angular momentum imparted to the fuel also being maintained in central flow opening 70.

Adjoining forwarding layer 60 is a second swirl-generating layer 61 which has a design very similar to that of first swirl-generating layer 59. However, the orientation of inlet areas 75 and of swirl channels 76 may vary from first swirl-generating layer 59. A special feature is primarily that swirl chamber 78 of second swirl-generating layer 61 has a larger opening width than does swirl chamber 68 of first swirl-generating layer 59. Second swirl-generating layer 61 is designed so that the entire second portion of the flow which flows through through openings 71 enters swirl channels 76. The entire flow leaves swirl disk 30 through a central outlet opening 79 in lower base layer 62.

The second flow which flows through second swirl-generating layer 61 leaves as a wide hollow cone lamella through outlet opening 79. An inner hollow cone lamella which flows into this outer hollow cone lamella is formed from the swirl flow which is created in first swirl-generating layer 59 and brought to a small diameter through narrow flow opening 70. Using swirl disk 30, it is thus possible to create two hollow conical lamellae, concentrically arranged one inside the other, which because of the enlarged spray surface achieve particularly fine atomization. A condition for optimal atomization is that the diameter of flow opening 70 of forwarding layer 60 must be smaller than the diameter of swirl chamber 78, and must be even smaller than the diameter of outlet opening 79 of base layer 62. Ideally, the cross sections of swirl channels 66 of first swirl-generating layer 59 are larger than those of swirl channels 76 of second swirl-generating layer 61, as the result of which the cone angle of the inner hollow cone lamella may be kept small in relation to the outer hollow cone lamella.

Swirl disk 30 is constructed in a plurality of metallic layers by electrodeposition (multilayer metal plating), for example. Based on manufacturing using deep lithographic electroplating methods, there are particular features in the contouring, several of which are briefly summarized below:

Layers having constant thickness over the disk surface,

As a result of the deep lithographic structuring, substantially vertical indentations in the layers which form the respective cavities having flow-through (as dictated by the manufacturing process, deviations of approximately 3° in relation to optimally vertical walls may be present),

Desired undercuts and overlaps of the indentations due to the multilayer construction of individually structured metal layers,

Indentations having any cross-sectional shapes which are essentially parallel to the axis, and

One-piece design of the swirl disk, since the individual metal depositions directly follow one another in succession.

In the following sections, the method of manufacturing swirl disks 30 will be explained only briefly. All the process steps for multilayer metal plating in the manufacture of a perforated disk have already been described in detail in German Unexamined Patent Application 196 07 288. One characteristic of the method of successive application of photolithographic steps (UV deep lithography) and subsequent microelectrodeposition is that high precision of structures is ensured, even on a large-surface scale, so that it is ideal for use in mass production involving a very large number of work pieces (high batchability). Numerous swirl disks 30 may be produced simultaneously on one panel or wafer.

The starting point for the method is a flat, stable substrate which may be made of metal (titanium, steel), silicon, glass, or ceramic, for example optionally, at least one auxiliary layer is applied to the substrate first. For this purpose, an electrodeposition base layer (TiCuTi, CrCuCr, Ni, for example) is used which is necessary for electrical conductance for the subsequent microelectrodeposition. The auxiliary layer is applied by sputtering or currentless metal deposition, for example. After this pretreatment of the substrate, a photoresist is applied to the entire surface of the auxiliary layer by lamination or spin-on deposition, for example.

The thickness of the photoresist should correspond to the thickness of the metal layer to be produced in the subsequent electrodeposition process, and thus to the thickness of lower base layer 62 of swirl disk 30. The resist layer may be made of one or multiple plies of a photostructurable film or a liquid resist (polyimide, photoresist). If a sacrificial layer is to be optionally plated onto the subsequently produced coating structure, the thickness of the photoresist should be increased by the thickness of the sacrificial layer. The metal structure to be produced should be inversely transferred into the photoresist using a photolithographic mask. Optionally, the photoresist may be exposed (UV deep lithography) to UV radiation (printed board or semiconductor exposure system) directly over the mask and subsequently developed.

The negative structure which ultimately results in the photoresist for subsequent layer 62 of swirl disk 30 is filled by electroplating with metal (Ni, NiCo, NiFe, NiW, Cu, for example). As the result of electrodeposition, the metal conforms closely to the contour of the negative structure so that the shape of the predetermined contour is faithfully reproduced in the negative structure. To produce the structure of swirl disk 30, the steps following the optional application of the auxiliary layer must be repeated corresponding to the number of layers desired, so that for a five-layer swirl disk 30, four (one-time lateral overgrowth) or five electrodeposition steps are carried out. Various other metals may be used for the layers of a swirl disk 30, provided that their use requires only one new electrodeposition step per layer.

After deposition of upper top layer 58, the remaining photoresist is leached from the metal structures by wet chemical stripping. For smooth, passivated substrates, swirl disks 30 may be detached from the substrate and isolated. For substrates having considerable adhesion of swirl disks 30, the sacrificial layer is etched away selectively with regard to the substrate and swirl disk 30, and swirl disks 30 may be lifted off the substrate and cut up.

What is claimed is:

1. A fuel injector for fuel injector systems of internal combustion engines, in particular for direct injection of fuel into a combustion chamber of an internal combustion engine, having a longitudinal valve axis (8), an actuator (1, 2, 14, 18, 19), a movable valve part (20) which, for the opening and closing of the valve, cooperates with a stationary valve seat (27) which is formed on a valve seat element (26), and having a swirl disk (30) situated downstream from the valve seat (27), the swirl disk having a multilayer design and having at least one inlet area (65) and at least one outlet area (79), and, between the inlet area (65) and the outlet area (79), the fluid to be spray-discharged being able to have a swirl component applied thereto,
wherein, in a first swirl-generating plane (59), a swirl component is imparted to a first portion of the flow, while a second portion of the flow is routed without swirl and independently of the first swirling portion of the flow, inside the swirl disk (30), and, in a second swirl-generating plane (61), a swirl component is imparted only to the second portion of the flow.

2. The fuel injector according to claim 1,
wherein the swirl disk (30) has five layers (58, 59, 60, 61, 62).

3. The fuel injector according to claim 1 or 2,
wherein the swirl disk (30) is able to be manufactured by electrodeposition of metal.

4. A fuel injector according to one of the preceding claims, wherein the swirl disk (30) has first and second swirl-generating planes (59, 61) designed in such a way that the flow leaves the outlet opening (70) as two hollow conical lamellae concentrically arranged one inside the other.

5. The fuel injector according to claim 4,
wherein the portions of the flow which form the two hollow conical lamellae swirl in the same direction.

6. The fuel injector according to one of the preceding claims, wherein the first and second swirl-generating planes (59, 61) are formed from swirl channels (66, 76) and a swirl chamber (68, 78), respectively.

7. The fuel injector according to claim 6,
wherein the swirl chamber (68) of the first swirl-generating plane (59) has an opening width which is smaller than that of the swirl chamber (78) of the second swirl-generating plane (61).

8. The fuel injector according to claim 6 or 7,
wherein the swirl channels (66) of the first swirl-generating plane (59) have a cross section which is larger than that of the swirl channels (76) of the second swirl-generating plane (61).

9. The fuel injector according to one of the preceding claims, wherein, between the first and the second swirl-generating planes (59, 61), a forwarding layer (60) is provided into which one flow opening (70) for the first swirling portion of the flow and at least one through opening (71) for the second portion of the flow without swirl, are introduced.

10. The fuel injector according to claim 9,
wherein the outlet opening (79) is introduced into a base layer (62), and the outlet opening (79) has a diameter which is larger than the flow opening (70) for the first swirling portion of the flow in the forwarding layer (60).
